(19) United States
(12) Patent Application Publication
(10) Pub. No.: US 2003/0029902 A1
(43) Pub. Date: Feb. 13, 2003

(54) Reinforced structural elements incorporating fiber-reinforced metal matrix composite wires and methods of producing the same

(75) Inventor: Joseph T. Blucher, Waltham, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: NORTHEASTERN UNIVERSITY

(21) Appl. No.: 10/188,989

(22) Filed: Jul. 2, 2002

Related U.S. Application Data
(60) Provisional application No. 60/302,514, filed on Jul. 2, 2001.
(60) Provisional application No. 60/304,971, filed on Jul. 12, 2001.

(51) Int. Cl. B23K 1/00; B22D 19/14

(52) U.S. Cl. 228/101; 164/97; 164/112

(57) ABSTRACT

A system using fiber reinforced metal matrix wire in castings increases the tensile strength of and/or the rigidity the resultant casting. Because the fiber reinforced metal matrix wire is formed by a method that limits the exposure of the fiber to excessive heat, the fiber retains its strength more than conventionally formed wires. This system is applicable to castings for preferential reinforcement—increasing tensile strength and rigidity, and to sandwich structures wherein the composite wires bracket and internal matrix or a metallic layer surrounds and is strengthened by a central composite wire.

### CROSS REFERENCE TO RELATED APPLICATIONS

This application claims priority under 35 U.S.C. §119(e) to provisional patent applications serial No. 60/302,514 filed Jul. 2, 2001 and provisional patent application No. 60/304,971 filed Jul. 12, 2001 the disclosures of both of which are hereby incorporated by reference.

### STATEMENT REGARDING FEDERALLY SPONSORED RESEARCH OR DEVELOPMENT

N/A

### BACKGROUND OF THE INVENTION

The present invention relates generally to casting structures and, more specifically, to utilizing fiber reinforced metal matrix composite wire in castings for preferential reinforcement and creating sandwich structures.

It is known that materials with superior mechanical properties may be developed as composite materials by embedding such reinforcing materials as carbon-based fibers, ceramic-based fibers, or ceramic particles in a metal matrix material such as an aluminum alloy. Such metal matrix composite materials can be manufactured by numerous processes such as one using a squeeze-casting machine such as that shown in FIGS. 1 and 2. In a precasting process, a preform 103 for reinforcing the casting is sintered to a desired shape after inorganic fibers or ceramic particles are mixed with water, dehydrated and dried. The preform 103 is placed in a metal mold 101, while a plunger pump 102 is filled with a molten metal 104 of matrix material. Then a piston 105 forces the metal matrix material to infiltrate into the preform in the metal mold to create a metal matrix composite 106. The metal composite casting may find various industrial applications including in airplanes and automobiles as a high-strength, light-weight composite material containing inorganic fibers or ceramic particles ranging from 10 to 50% by volume.

Such a manufacturing method of metal matrix composite materials has a limitation in that it is difficult to place fibers only in specific portions of the mold rather than throughout the whole cross section. When small particles with a significantly different specific gravity than the filling material is used, buoyancy-induced particle separation may occur. Fiber may be displaced from the intended location by the flow of the metal matrix and motion may occur during metal infiltration between the fibers making it difficult to manufacture composite materials with a high content of reinforcing fiber at a specific location. In addition, many fibers resist wetting by the molten metallic matrix unless an applied pressure is used. The pressure required to assure wetting requires such heavy equipment as to render the process impractical in some cases.

Options to limit the movement of fibers have been to secure the preform in a position before casting or weigh the fibers down so they do not float in the molten metal. Neither of these methods has provided a universally acceptable solution. Applying a high hydrostatic pressure when ceramic or carbon fibers are to be wetted by a molten metal matrix material requires extreme pressures that can be as high as 8.25 Mpa. This pressure requires heavy, expensive equipment that is limited in size. Therefore the applicability of this process is limited and not economical. In addition, traditional pressure infiltration subjects the metal matrix and fibers to a long exposure time at a high temperature, which allows adverse reactions to deteriorate the mechanical properties of the product.

Continuous processes for production of a fiber-reinforced composite wire with superior characteristics in durability and reliability are described in U.S. Pat. No. 5,736,199 and patent application Ser. No. 09/824,907 filed Apr. 3, 2001, the disclosures of which are incorporated by reference herein. The continuous infiltration process uses a metal infiltration apparatus 20 such as shown in FIG. 3.

The apparatus 20 is composed of a source of multiple strands of fiber 2, an optional desizing and/or surface treating furnace 4, a pressure chamber 8 and a bath container 10 for a molten metal 18, such as aluminum, aluminum alloy, magnesium or copper. The bath container is heated by a heater (not shown) and both the bath container 10 and the pressure chamber 8 are equipped with orifices for passing the fiber bundles 15 through the bath and pressure chamber 8. These orifices maintain a temperature gradient across their length that facilitates the passage and infiltration of the fiber bundle 15 without loss of molten metal 18 or pressure due to the passage.

Fiber tows 2 pass through the optional furnace 4 in which sizing, if present, is burned off. Additionally the surface of the fibers may be treated by a mixture of gases to improve wettability. After leaving the furnace 4, the fiber bundles pass through the lower gate 12 into the molten bath 18 and from there they exit to a take-up reel 16. The molten metal is typically kept 40° C. above the melting temperature of the metal. The pressure required for optimum infiltration is about 1.2 MPa for ceramic fibers and about 8.25 MPa for carbon fibers.

The system of FIG. 3 has produced wires of 0.2 mm to 2.5 mm diameter at speeds up to 20 meters per minute. The strength of the composite wires produced by this process has been significantly superior to composite elements produced by batch processes, which also cannot produce the length of wire manufacturable by the above process. Preferred composite wires are utilize 55 v/o Nextel 440 fiber content in a 99.9% aluminum matrix.

While the composite wires with superior properties have now been manufactured and found useful, they have hithertofore not been successfully applied to castings.

### BRIEF SUMMARY OF THE INVENTION

Applications of fiber reinforced metal matrix wires, whose manufacture has previously been described, show beneficial mechanical properties when used to reinforce castings. The wires can have diameters ranging between about 0.1 mm and 3.0 mm. The fiber reinforcement for metal matrix composite wires can be made of ceramics. hi-performance polymer or different grades of carbon fibers for instance; Nextel 610 fiber, Ube SiC fiber, Sumitomo Altex fiber, Textron SiC fiber. The volume percentage of fibers can range between 35 to 65%. The matrix of the composite wire can be made from aluminum, copper, magnesium, aluminum alloy or copper alloy. Such reinforcement is particularly applicable when casting forms, such an engine block, that are known to experience a maximum stress only in particular locations. If the casting can be reinforced in the regions of maximum stress, the rest of the casting can be made lighter rendering the entire casting lighter and stronger than a casting without such reinforcement. Application in preferential regions is an alternate to applications where the reinforcement is applied throughout the casting.

In a first embodiment, a metal matrix composite clad wire comprises a fiber reinforced metal matrix composite wire core with a layer of cladding deposited on the composite wire core when the composite wire core passed through a co-extrusion mechanism charged with a molten metal matrix. This clad wire exhibited superior durability and strength. This clad wire could alternately be made by a co-drawing process in which a fiber reinforced metal matrix composite wire core is clad by having a layer of cladding wrapped around the composite wire core when the composite wire core passed through co-drawing mechanism charged with sheet metal cladding material.

In a second embodiment, a reinforced panel structure is comprised of a layer of fiber reinforced metal matrix composite wire on the opposite flat surfaces of a panel with the center of the panel and the inter-wire spaces filled by a metal matrix. This panel shows increased rigidity with minimal change in weight from an unreinforced panel. The weight of the panel is reduced when the panel is composed of a layer of fiber reinforced metal matrix composite wires on opposite surfaces of a panel where the internal space is filled by hollow ceramic microspheres that are incorporated in a metallic matrix that also incorporates the composite wires into the panel. This panel has a particularly advantageous strength to weight ratio.

In a third embodiment, a preferentially reinforced casting is comprised of metal matrix fiber core composite wires incorporated into a cast shape at stress points. This allows the cast shape to be lighter than if the entire cast had the strength needed at the high stress points. Other aspects, features, and advantages of the present invention are disclosed in the detailed description that follows.

### BRIEF DESCRIPTION OF THE SEVERAL VIEWS OF THE DRAWING

The invention will be more fully understood by reference to the following detailed description when considered in conjunction with the accompanying drawings, in which:

FIG. 1 is a schematic diagram of a prior art method and apparatus of manufacturing a composite material;

FIG. 2 is a schematic diagram of the method and apparatus of FIG. 1, after completion of the steps illustrated by FIG. 1;

FIG. 3 is a schematic diagram of a prior art process and apparatus to form fiber reinforced metal matrix wires;

FIG. 4A is a longitudinal cross section of a casting mold to cast tensile specimens with reinforcement according to the invention;

FIG. 4B is an illustration of the tension specimens cast using the process of FIG. 4A;

FIGS. 5A and 5B are illustrations of the cross sections at the gauge length and head respectively of tension specimens according to the process of FIG. 4A;

FIG. 6 is a top view of a casting mold to cast reinforced proving rings according to the invention;

FIG. 7A is an illustration of the proving rings cast using the mold of FIG. 6;

FIG. 7B is a cross section of the composite wire reinforced proving ring of FIG. 7A; and

FIGS. 8A and 8B are graphs contrasting the deflection of the proving rings of FIG. 7A with and without composite wire reinforcement.

FIG. 9 is a schematic diagram of a co-drawing/co-extrusion apparatus that could be used to clad composite wires according to the invention;

FIG. 10 is a cross section of a fiber reinforced composite wire clad by aluminum according to the process of FIG. 9;

FIGS. 11A and 11B are side views of a casting mold to cast structured plates with reinforcement according to the invention;

FIGS. 12A and 12B are illustrations of the cross sections of reinforced plates according to the process of FIG. 11;

FIG. 13 is a graph showing the difference in deflection among the plates of FIG. 11;

FIG. 14 is a side view of a casting mold to cast structured panels filled with microspheres according to the invention;

FIG. 15A is an illustration of a cross section of the structured panels filled with microspheres according to the process of FIG. 14; and

FIG. 15B is a graph contrasting the loading vs deflection of the structured panels molded according to the process of FIG. 14 to unreinforced panels.

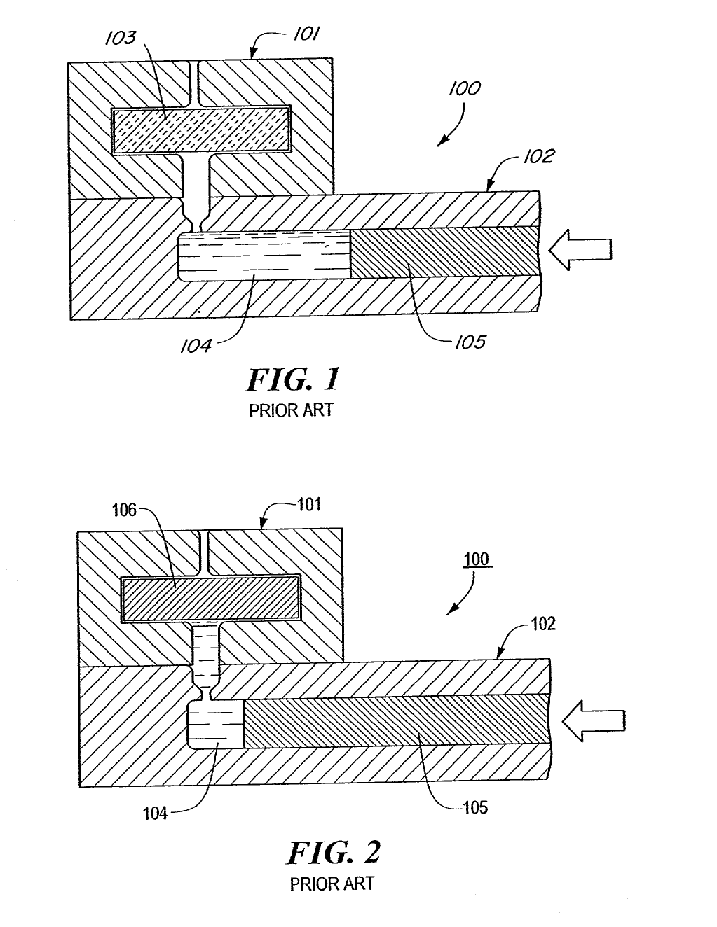

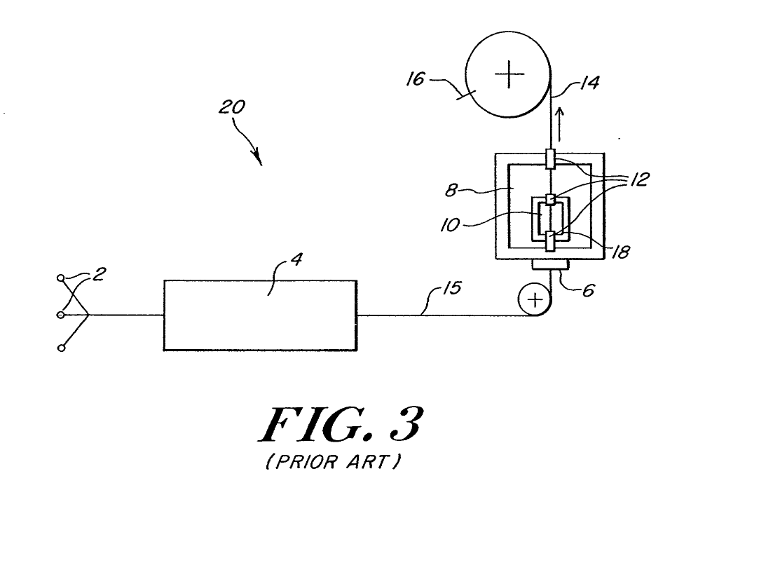

### DETAILED DESCRIPTION OF THE INVENTION

Fiber-reinforced metal matrix composite wires (hereinafter composite wires) make it possible to reinforce metallic constructs with greater precision in placement of the fiber reinforcement, both for preferential reinforcement and general reinforcement. In addition, due to the improved wetting characteristics of the composite wires, the casting can be accomplished at normal gravity pressure in most cases. Reinforcement of castings with the composite wires placed in stress regions of traditional castings or used to create sandwich structures have shown good results. Differing geometries require differing embodiments to integrate the composite wires with the casting material. The arrangement of wires for strengthening layered structured composites depend on both the type of loading and the type of distribution of the reinforcement.

The load carrying capacity of composite wire reinforced specimens depends not only on the composite wires interface properties between individual fibers and matrix material and the v/o (volume percent) of fibers, but also on the macroscopic distribution of the composite wires. When the composite wires are separated in the unreinforced metal matrix, crack initiation in the individual composite wires is delayed. Failure of the composite wires occurs in close but still staggered steps resulting in a gradual release of stored energy. Since composite wires can be manufactured on an industrial scale with good economy, their application to casting opens possibilities for the manufacture of new structures with advantageous mechanical properties. These composite wires can facilitate the production of preferentially or fully reinforced light metal castings.

Descriptions of embodiments are given below. These embodiments compare the action of castings and structures without reinforcement with those reinforced by composite wires. Many samples were also cast with directly introduced fiber-only reinforcement but these required a different (high pressure) process and showed the expected deficiencies discussed previously so are not detailed below.

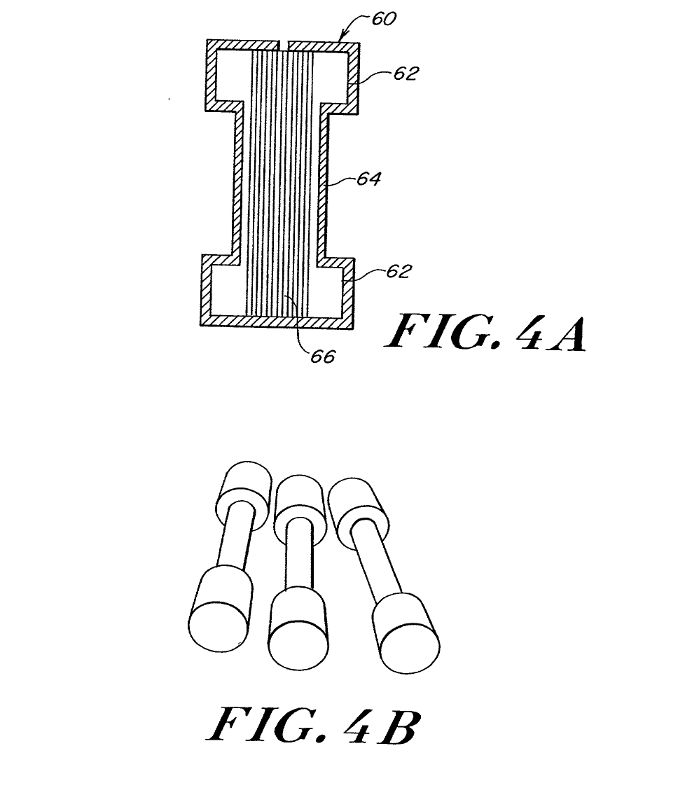

A first embodiment of the application of composite wires is selective reinforcement of traditional castings to improve the tensile strength. Tensile specimens are used to assess the change in tensile strength because the extrapolation of the data derived from them to specific applications is well known. Such specimens are cast using molds with reinforcement positioned as shown in FIG. 4A. Each mold 60 has two identical heads 62 and a gauge length 64 running between the heads. Reinforcement material 66, if used, is aligned with the length of the specimen. Each finished specimen is placed on a test fixture where the tensile strength is measured.

### EXAMPLE

Three types of tensile specimens were cast with the same casting metal; an unreinforced specimen, and two specimens reinforced with composite wire having different fiber cores. The two types of fibers were: Pitch 25 carbon fibers and Nextel 440 ceramic fibers. In all cases, the casting alloy was #413 Al with 12% Si having a liquidus temperature of 587° C. The melt was at 610° C. and the graphite molds were at the same temperature. The parameters of the specimens are listed in Table 1.

TABLE 1

| | | | | Nextel 400 | |
|---|---|---|---|---|---|
| | All cast | Pitch 25 carbon | | ceramic fiber | |
| | metal | composite wire | | composite wire | |
| Wire | | 55 | v/o fiber | 55 | v/o fiber |
| Composition | | 99.9% | Aluminum | 99.9% | Aluminum |
| Diameter | | 1.4 | mm | 1.6 | mm |
| Casting | gravity | gravity | | gravity | |
| Pressure | | | | | |
| Average v/o | 0 | 28.2% | | 37% | |
| of | | | | | |
| reinforcement | | | | | |
| Strength | 105.5 | 259.6 | | 228 | |
| (MPa) | | | | | |

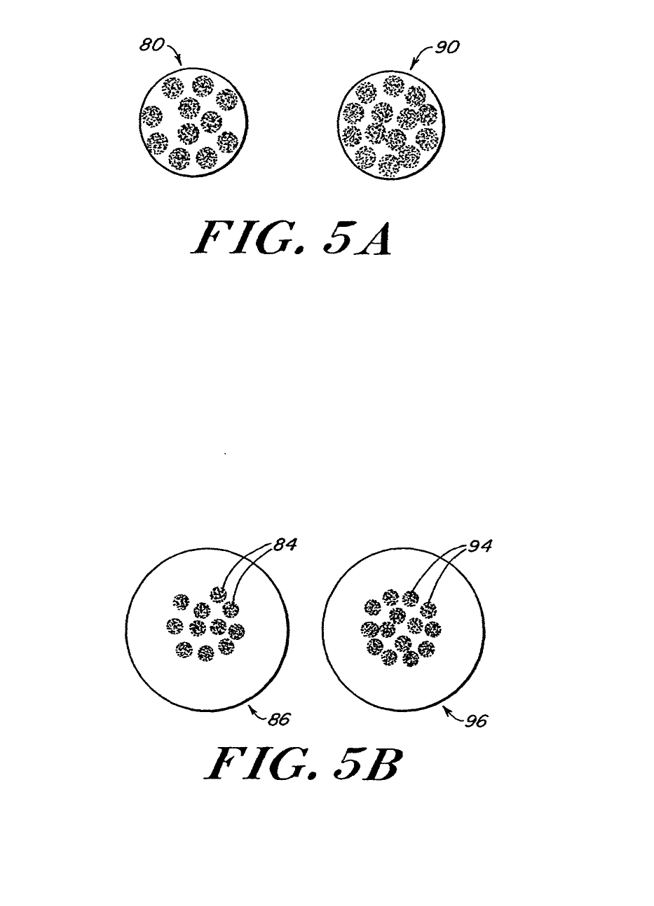

FIG. 4B illustrates the cast tensile specimens produced and FIG. 5 shows the cross sections of the composite wire reinforced castings. FIG. 5A shows the cross sections at the gauge lengths 64 of the specimens while FIG. 5B shows the cross sections at a head 62. Note the even distribution indicating the stability of the reinforcement placement because of the similar specific gravities between the composite wire and the matrix material. Cross section 80 is the specimen with carbon composite wire reinforcement and cross section 90 is the specimen with Nextel composite wire reinforcement. Each of these cross sections show the composite wires 84, 94 evenly distributed and centered. The strength of the specimens is more than doubled for each of the composite wire reinforcements.

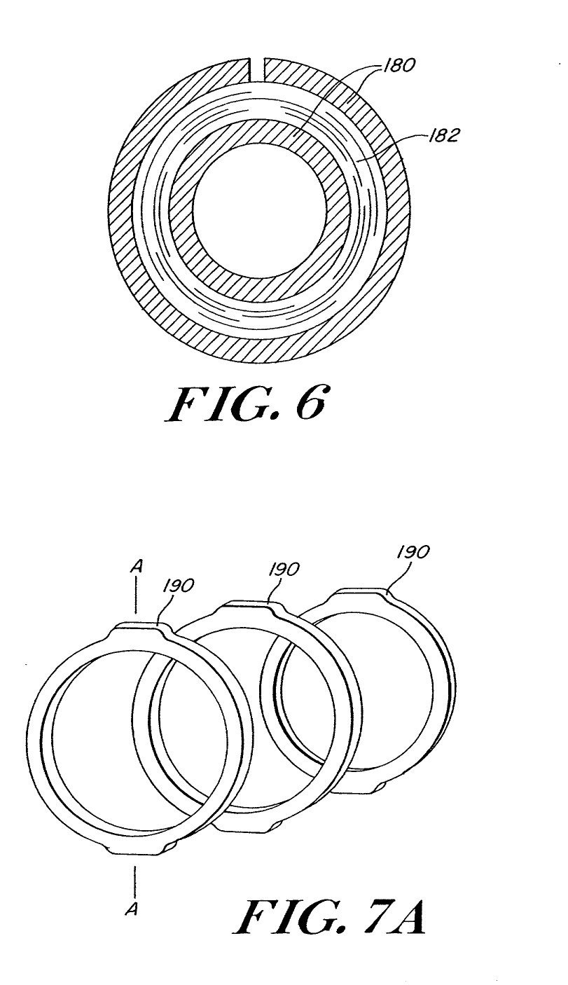

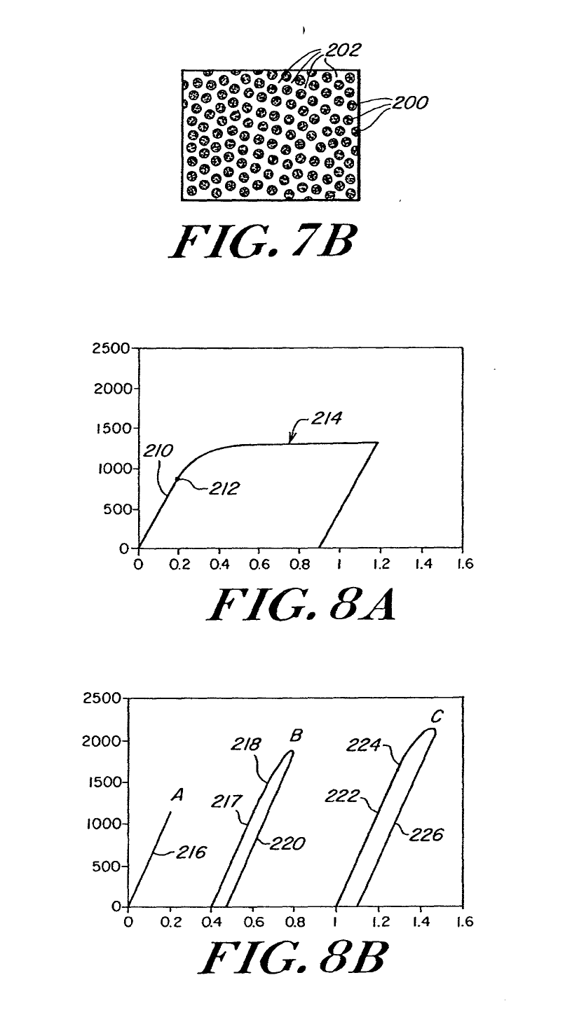

A second embodiment of reinforcing a casting with composite wire applies to reinforcement circumferentially, such as in cylinders. Proving rings are well known as a testing specimen for measurement and analysis for this configuration. The rings are typically tested for strength and rigidity. FIG. 6 is a top view of a mold 180 for a proving ring shown with composite wires 182 placed inside the mold. Once the composite wires are placed, the molten metal is introduced at gravity. FIG. 7A shows proving rings 190 made in such a mold.

### EXAMPLE

Three inch proving rings of #413 AlSi alloy alone and #413 AlSi alloy reinforced with composite wires made with 55 v/o Nextel fibers having a diameter of 0.6 mm were manufactured. The composite wire was laid in the mold by winding the wire around the center of the mold. A cross section of the reinforced proving ring is shown in FIG. 7B. The even distribution of the composite wires 200 and complete filling of the intervening spaces 202 is evident in FIG. 7B. Both types of rings were loaded in the direction of the vertical diagonal, line A-A in FIG. 7A. Deflections were measured with a Linear Variable Differential Transformer (LVDT) placed inside the rings in the direction of the loading. FIG. 8A shows the curve for the unreinforced ring. Proportional deformation, indicated by 210, was observed until the load reached 890N, indicated by 212, with a deflection of about 0.2 mm. Subsequently, the unreinforced ring showed a permanent deformation, indicated by 214, of an additional 0.812 mm at the maximum applied load of 1335N. The unreinforced ring was not tested to destruction.

FIG. 8B shows the curve(s) for the test of a composite wire reinforced ring. In a first trial A, the ring was cycled three times to the 1335N limit that deformed the unreinforced ring. The reinforced ring showed proportional deformation, indicated by 216, of about 0.2 mm with no measurable permanent deformation. In follow-on trial B, the same reinforced ring was loaded up to 1780N. Proportional deformation, indicated by 217, ceased at 1424N, indicated by 218, and the 1780N load resulted in about a 0.05 mm permanent deformation. After removing the load, the 1780N load was tried again. Repeating the load showed proportional deformation, indicated by 220, all the way up to the 1780N limit and no further permanent deformation. In a third trial C, the same ring was loaded to 2225N. Proportional deformation, indicated by 222, was seen until 1780N, indicated by 224, and permanent deformation of about an additional 0.076 mm was seen after 1780N. After removing the load, this load was tried again. Repeating the cycle to a 2225N load showed proportional distortion, indicated by 227, all the way to the 2225N limit with no further permanent deformation. The composite wire reinforced ring was not tested to failure. The elastic (proportional deformation) range of the reinforced proving rings showed a four-fold increase.

A third embodiment of the use of composite wires as a reinforcing element incorporated the composite wire in a clad wire. Although the composite wires can be used directly in wire form as load carrying structural elements such as stringers or tie wires, the composite wires exhibit some relative brittleness that must be taken into account when designing with them. When the composite wires are used as the core of a clad wire the clad wire shows improved handling characteristics.

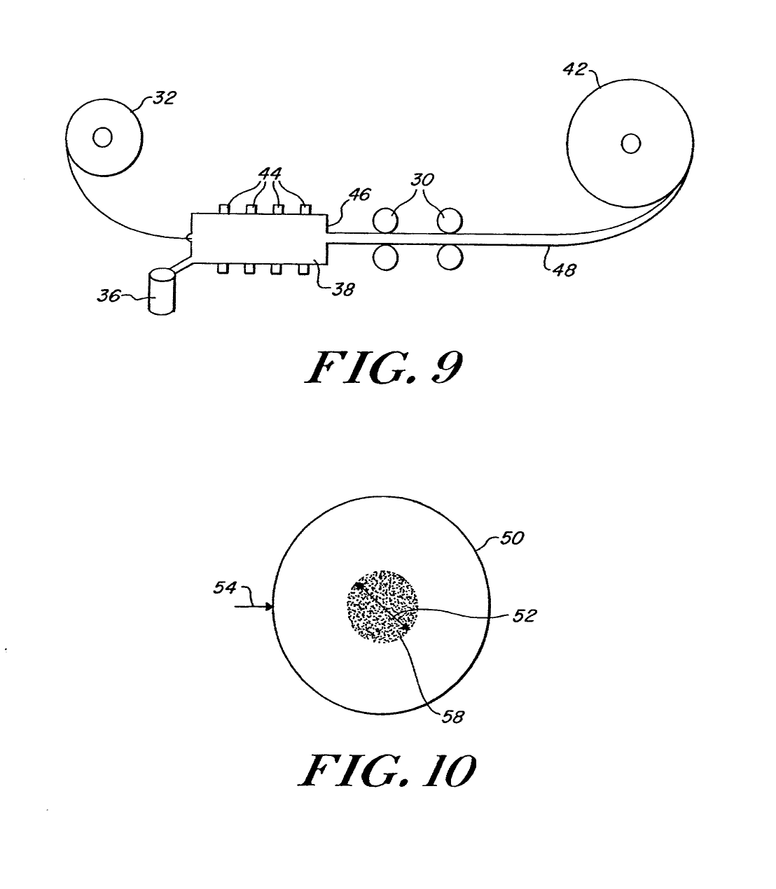

A co-drawing or co-extrusion process such as that illustrated in FIG. 9 can be used to manufacture clad wire. In co-extrusion, the composite wire 32 is supplied from a reel to the entry to the co-extrusion die 38 that also has a metal injection apparatus 36. The co-extrusion die is equipped with distributed heaters that maintain the temperature as needed. As the composite wire passes through the die, it picks up a cladding of the metal injected into the die. The puller mechanism 30 is positioned a sufficient distance from the exit 46 of the die such that the clad wire 48 is solidified when the force is applied. The puller mechanism pulls the clad wire from the co-extrusion apparatus. Take-up reel 42 provides storage for the finished clad wire 48. In such a clad wire, both the reinforcing composite wire core and the cladding are under uniaxial tensile load.

### EXAMPLE

An aluminum clad wire 50 as shown in FIG. 10 was created. A 1.6 mm diameter 52 composite wire 58 with approximately 55 v/o Nextel 440 fiber content in 99.9% aluminum matrix was used. The composite wire was jacketed into 5001 aluminum forming a clad wire having an outside diameter 54 of 4.8 mm. The tensile strength of this clad wire was 206 MPA, a 75% increase compared to a similar unreinforced aluminum wire. The calculated specific weight of the clad wire was 2.9 g/cc a slight increase over the 2.7 g/cc specific weight of the cladding aluminum. Therefore, the strength to weight ratio of the composite wire reinforced clad wire was 3-4 times better than unreinforced wire. The clad wire could be bent to a minimum radius of 300 mm without failure of the composite wire and without separation of the composite wire from the cladding. The clad wires could be joined lengthwise with crimp clamps without loss of axial load carrying capacity. Similar clad wire using copper, copper alloy, aluminum alloy, and magnesium as the cladding layer is also possible. The range of diameters of clad wires are between 1.0 mm and 6.0 mm.

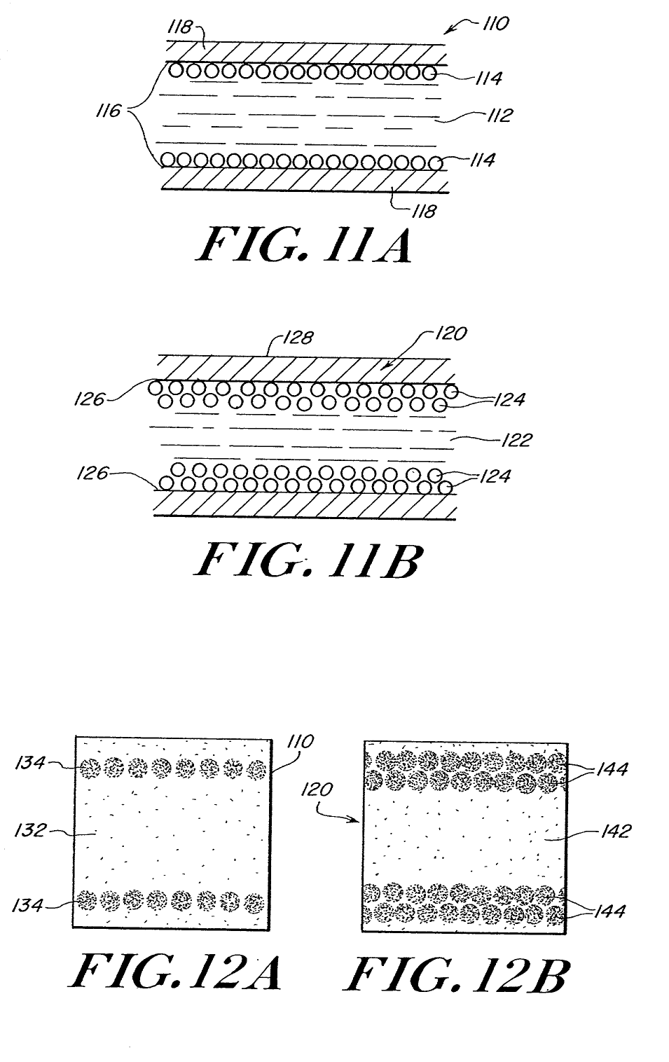

A fourth embodiment utilizes the composite wire to create reinforced panels (or plates) that are structures with better properties than without the reinforcement. FIG. 11A shows in cross section a mold 118 prepared by layering composite wires 114 on the outer surfaces 116 of the mold 118 and holding them there with a preparation such as glue. When molten metal 112 at gravity pressure fills the mold 118, the mold 118 and the spaces between the composite wires 114 are filled. FIG. 11B shows in cross section the same process utilizing a double layer of composite wires 124.

Specimens from the panels were subjected to a three-point bend test with the reinforcing composite wires parallel to the long axis of a test specimen. The testing yielded a plot of the bending moment applied versus the panel displacement. When the mode of loading is bending, panel deformations are not uniform across the cross sections. In the outer reinforced layers, the deformations are elastic until failure under normal compression or tension stresses. Failure usually occurs with a sudden crack propagation. Typically, the greater the rigidity (higher proportional displacement limit) of the panel, the stronger the panel. The composite wire reinforced panels display a significantly increased rigidity over panels without such reinforcement.

### EXAMPLE

A parallel layered sandwich panel with an approximately 12 mm thickness was fabricated by placing composite wires on the outer surfaces of a mold and filling the space in the mold with #413 Al 12% Si alloy. The composite wire used was 1.5 mm diameter wire with 55 v/o Nextel fibers. Gravity pressure was used during the casting. Panels with both a single layer and a double layer of composite wires were made. FIGS. 15A illustrates a cross section of the double layer reinforced panels 110. The figures show the composite wires 134, 144, the solidified metal matrix 132, 142 and the complete filling of the space between composite wires 134, 144.

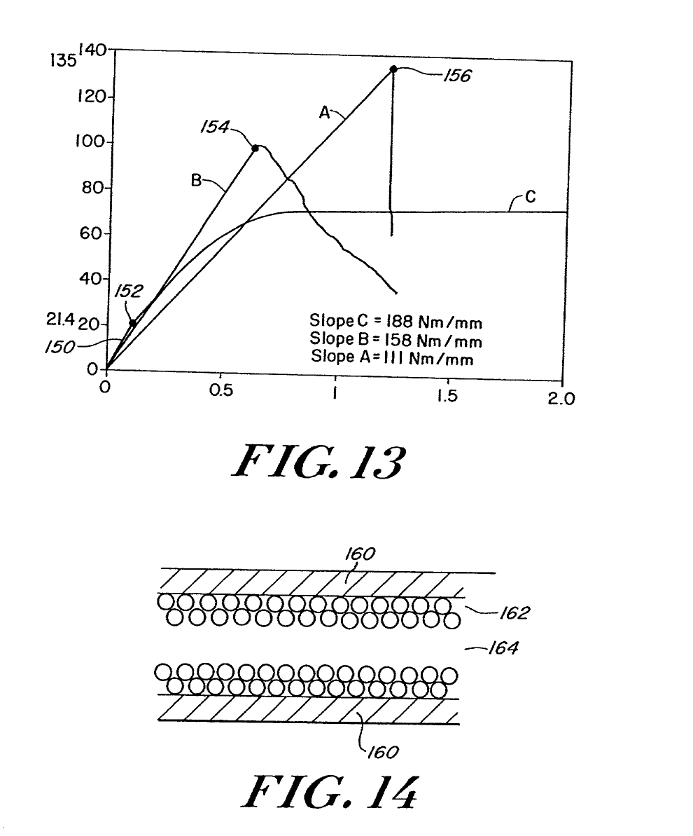

For comparison to the reinforced panels 110, 120, an unreinforced panel (not illustrated) was cast under thermal cycle conditions similar to those used in the production of the reinforced panels. All panels were cut into specimens (12 mm×12 mm×4in) for test. FIG. 13 shows the deflection curves for the single layer (A), double layer (B), and unreinforced (C), specimens. Note that for the reinforced panels, the layers of composite wires are on both the compression and the tension side of the outer surfaces of the plates.

As seen in FIG. 13, the unreinforced panel (curve C) proportionally distorts until a moment of 21.4 Nm, indicated by 152, has been applied. At that moment, the deflection was about 0.11 mm. After the region of proportional distortion, the unreinforced specimen plastically distorted with a maximum moment of about 63 Nm. The panel reinforced with a single layer of composite wires (curve A) showed proportional distortion until a moment of about 135 Nm, a significant increase. At that moment, the deflection was about 1.21 mm. After the region of proportional distortion, the panel reinforced by the single layer of composite wires suffered a catastrophic crack. The panel reinforced with a double layer of composite wires (curve B) showed proportional distortion until a moment of about 99.8 Nm, also a significant increase. At that moment, the deflection was about 0.63 mm. After the region of proportional distortion, the panel reinforced by a double layer of composite wires failed with some plastic deformation before also suffering a catastrophic crack.

A fifth embodiment provides panels with a higher rigidity at a lower weight than either unreinforced panels or solid sandwich (fourth embodiment) panels. The panels of this embodiment are fabricated by placing hollow ceramic microspheres between external layers of composite wire reinforcement in a mold and infiltrating the filled mold with a metal matrix material. The ceramic may be for instance, aluminum oxide, silica, or combinations thereof, but in particular fly-ash is well adapted to this application. Metals suitable for use as the metal matrix material include aluminum, magnesium, copper and alloys of these when fly-ash is not used. Since fly-ash (an AlO/SiO and other oxides combination) reacted with the matrix at approximately 700° C., only aluminum or aluminum alloys can be used as the metal matrix material with fly-ash. The resulting panels have a low specific weight, high compressive strength, moderately good thermal conductivity, excellent thermal stability, good damping properties, and excellent machinability. When the metal matrix is aluminum, specific weights as low as 1.3 gm/cc (vs. aluminum's 2.7 gm/cc) can be achieved. A magnesium matrix can exhibit a specific weight as low as 0.93 gm/cc. Structural panels and components made using this process are well suited for aircraft, space craft and jet engine compartment components.

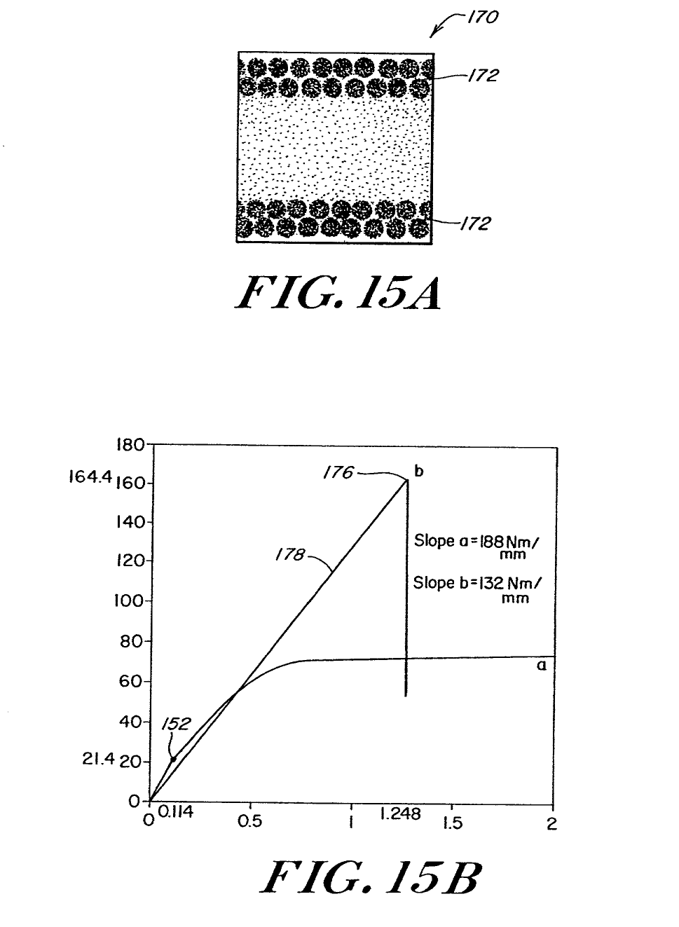

FIG. 14 illustrates an end view of the mold lay-up for forming these panels. A mold 160 has a layer of composite wires 162 placed on the top and bottom surfaces. Such a layer may be formed of one or multiple rows of the composite wires. A quantity of hollow ceramic microspheres 164 fills the space between the layers of composite wires 162. The mold is placed filled with molten metal matrix to infiltrate the material in the mold.

### EXAMPLE

Two layers of 1.5 mm diameter 55 v/o Nextel fiber in 99.9% aluminum composite wires were used to bracket a sufficient volume of fly-ash to create a 12 mm thick panel. The microspheres had an average diameter of 100 microns and a wall thickness of approximately 10 microns. The chemical composition of the fly-ash, a silicon oxide/aluminum oxide combination, was close to that of mullite. A molten metal of #413 Al-Si alloy was added into the mold. A cross section of the resulting panel 170 is shown in FIG. 15A. The metal matrix is well distributed among the composite wires 172 and microspheres. The specific weight of the resultant panel was 2.1 g/cc. A specimen of the microsphere panel was prepared as detailed above and tested. The rigidity of the microsphere panel and an unreinforced panel are shown in FIG. 15B. The unreinforced panel (curve a) proportionally distorts until a moment of 21.4 Nm, indicated by 152, is applied. At that moment, the deflection is about 0.11 nm. After the region of proportional distortion, the unreinforced specimen plastically distorts. The microsphere and composite wire reinforced panel (curve b) proportionally distorts until a moment of about 164.4 Nm, indicated by 176, is applied. This is significantly higher than the unreinforced panel and an improvement, at a much lower weight, over the solid sandwich panels of FIG. 12. At that force, the deflection is about 1.24 mm. After the region of proportional distortion, the composite wire and microsphere reinforced panel fails because of brittleness with delamination of the panel occurring.

Having described preferred embodiments of the invention it will now become apparent to those of ordinary skill in the art that other embodiments incorporating these concepts may be used. Accordingly, it is submitted that the invention should not be limited by the described embodiments but rather should only be limited by the spirit and scope of the appended claims.

What is claimed is:

1. A composite reinforced structural element comprising:
a solid body formed of a metal material; and
composite reinforcing wires disposed within the solid body, each of the composite reinforcing wires comprising a metal matrix reinforced with continuous fibers extending lengthwise along the wire.

2. The wire of claim 1, wherein the fibers are formed of a material comprising a ceramic material or carbon.

3. The wire of claim 2, wherein the ceramic material comprises Nextel 440.

4. The wire of claim 1, wherein the metal matrix of the reinforcing wires is formed of a metal material comprising aluminum, an aluminum alloy, copper, a copper alloy, magnesium, or a magnesium alloy.

5. The structural element of claim 1, wherein the metal material of the solid body comprises an aluminum alloy.

6. The structural element of claim 1, wherein the metal material of the solid body comprises an aluminum alloy including 12% silicon.

7. The structural element of claim 1, further including hollow microspheres disposed within the solid body.

8. The structural element of claim 7, wherein the hollow microspheres are formed from a ceramic material.

9. The structural element of claim 8, wherein the ceramic material comprises aluminum oxide, silica, or a combination of aluminum oxide and silica.

10. The structural element of claim 8, wherein the ceramic material comprises fly ash.

11. The structural element of claim 1, wherein the hollow microspheres are disposed between layers of the reinforcing wires.

12. The structural element of claim 1, wherein the reinforcing wires include an outer layer of metal cladding.

13. The structural element of claim 1, wherein the cladding is formed from a metal material comprising aluminum, an aluminum alloy, copper, a copper alloy, magnesium, or a magnesium alloy.

14. The structural element of claim 1, wherein the reinforcing wires are disposed within the solid body at points subject to stress.

15. The structural element of claim 1, wherein the solid body is in the form of a ring or a cylinder, and the reinforcing wires are disposed annularly within the solid body.

16. The structural element of claim 1, wherein the solid body is in the form of a ring or a cylinder, and the reinforcing wires are disposed in a winding form within the solid body.

17. The structural element of claim 1, wherein the solid body is in the form of a panel having upper and lower surfaces, and the reinforcing wires are disposed in at least one layer adjacent the upper surface and at least one layer adjacent the lower surface.

18. The structural element of claim 1, wherein the solid body is in the form of a panel having upper and lower surfaces, and the reinforcing wires are disposed in two layers adjacent the upper surface and two layers adjacent the lower surface.

19. The structural element of claim 1, wherein the solid body is in the form of a tensile element.

20. The structural element of claim 1, wherein the composite reinforcing wires have a specific gravity sufficiently similar to a specific gravity of the solid body such that the reinforcing wires do not substantially move within the solid body in a molten state.

21. The structural element of claim 1, wherein the reinforcing elements are tensile elements.

22. A metal matrix composite clad wire comprising:
a core comprising a composite wire comprising a metal matrix reinforced with fibers; and
a layer of metal cladding surrounding the composite wire.

23. The wire of claim 22, wherein the fibers are formed of a material comprising a ceramic material or carbon.

24. The wire of claim 23, wherein the ceramic material comprises Nextel 440.

25. The wire of claim 22, wherein the metal matrix is formed of a metal material comprising aluminum.

26. The wire of claim 22, wherein the metal cladding is formed from a metal material comprising aluminum, an aluminum alloy, copper, a copper ally, magnesium, or a magnesium alloy.

27. A method for producing the wire of claim 22, comprising:
transporting the composite wire through a die; and
injecting the metal cladding in a molten state around the composite wire within the die.

28. A method for producing a composite reinforced structural element comprising:
providing a mold;
placing a plurality of composite reinforcing wires within the mold, each of the composite reinforcing wires comprising a metal matrix reinforced with continuous fibers extending lengthwise along the wire;
filling the mold with a molten metal material; and
allowing the molten metal material to solidify.

29. The method of claim 28, wherein the reinforcing wires are held in the mold with glue.

30. The method of claim 28, wherein the mold is in the form of a panel.

31. The method of claim 28, wherein the mold is in the form of a ring or a cylinder.

32. The method of claim 28, wherein the mold is in the form of a tensile element.

33. The method of claim 28, wherein the fibers are formed of a material comprising a ceramic material or carbon.

34. The method of claim 33, wherein the ceramic material comprises Nextel 440.

35. The method of claim 28, wherein the metal matrix of the reinforcing wires is formed of a metal material comprising aluminum, an aluminum alloy, copper, a copper alloy, magnesium, or a magnesium alloy.

36. The structural element of claim 28, wherein the molten metal material comprises an aluminum alloy.

37. The structural element of claim 28, wherein the molten metal material comprises an aluminum alloy including 12% silicon.
